(19) United States
(12) Patent Application Publication
(10) Pub. No.: US 2026/0249703 A1
(43) Pub. Date: Aug. 27, 2026

(54) ELECTRIFIED VEHICLE

(71) Applicant: TOYOTA JIDOSHA KABUSHIKI KAISHA, Toyota-shi (JP)

(72) Inventor: Akihiro KITAO, Nishshiri-shi (JP)

(73) Assignee: TOYOTA JIDOSHA KABUSHIKI KAISHA, Toyota-shi (JP)

(21) Appl. No.: 19/364,175

(22) Filed: Oct. 21, 2025

(30) Foreign Application Priority Data
Feb. 25, 2025 (JP) 2025-028313

(51) Int. Cl. B60L 7/18

(52) U.S. Cl. CPC B60L 7/18; B60L 2250/26

(57) ABSTRACT

An electrified vehicle includes an electric motor that is coupled to a drive wheel via a clutch, a stroke sensor that detects a clutch stroke, a braking device, and one or more electronic control units. The braking device is configured to apply a regenerative brake torque to the drive wheel by controlling the electric motor and apply a frictional brake torque to the drive wheel by supplying a brake oil pressure to a wheel cylinder of the drive wheel. In a case where the clutch pedal is depressed during execution of regenerative braking in which the regenerative brake torque is applied to the drive wheel, the one or more electronic control units execute a brake oil pressure increase process of controlling the braking device such that a brake oil pressure corresponding to the clutch stroke detected by the stroke sensor is added to the wheel cylinder.

### CROSS-REFERENCE TO RELATED APPLICATION

This application claims priority to Japanese Patent Application No. 2025-028313 filed on February 25, 2025. The disclosure of the above-identified application, including the specification, drawings, and claims, is incorporated by reference herein in its entirety.

### BACKGROUND

### 1. Technical Field

The present disclosure relates to an electrified vehicle including an electric motor connected to a drive wheel via a clutch.

### 2. Description of Related Art

Japanese Unexamined Patent Application Publication No. 2011-183961 (JP 2011-183961 A) discloses a brake control device that performs regenerative cooperative brake control of an electrified vehicle.

### SUMMARY

In an electrified vehicle including an electric motor connected to a drive wheel via a clutch, regenerative brake torque may not act on the drive wheel when a clutch pedal is depressed during execution of regenerative braking. In this case, a driver is required to further depress a brake pedal.

The present disclosure has been made in view of the above-described problems. The present disclosure provides an electrified vehicle capable of reducing a change in a vehicle braking force while avoiding or reducing further depression of a brake pedal performed by a driver in a case where a clutch pedal is depressed during execution of regenerative braking.

An electrified vehicle according to the present disclosure includes an electric motor, a stroke sensor, a braking device, and one or more electronic control units. The electric motor is connected to a drive wheel via a clutch. The stroke sensor is configured to measure a clutch stroke that is a depression amount of a clutch pedal for operating the clutch. The braking device is configured to apply regenerative brake torque to the drive wheel by controlling the electric motor, and apply frictional brake torque to the drive wheel by supplying a brake oil pressure to a wheel cylinder of the drive wheel. The one or more electronic control units are configured to execute, when the clutch pedal is depressed during execution of regenerative braking in which the regenerative brake torque is applied to the drive wheel, an oil pressure increase process of controlling the braking device such that the brake oil pressure corresponding to the clutch stroke measured by the stroke sensor is applied to the wheel cylinder.

According to the present disclosure, it is possible to apply a brake oil pressure of an appropriate magnitude corresponding to a decrease in regenerative brake torque corresponding to a clutch stroke in a case where a clutch pedal is depressed during execution of regenerative braking. Accordingly, it is possible to reduce a change in a vehicle braking force while avoiding or reducing further depression of a brake pedal performed by a driver.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing a configuration example of an electrified vehicle according to an embodiment;

FIG. 2 is a diagram for describing a basic configuration of a regenerative blended brake control;

FIG. 3 is a diagram for describing an outline of a brake oil pressure increase process according to the embodiment;

FIG. 4 is a flowchart showing details of the brake oil pressure increase process according to the embodiment; and

FIG. 5 is a graph showing a relationship between a clutch stroke and a transmission efficiency.

### DETAILED DESCRIPTION OF EMBODIMENTS

Embodiments of the present disclosure will be described with reference to the accompanying drawings.

### 1. Configuration of Electrified Vehicle

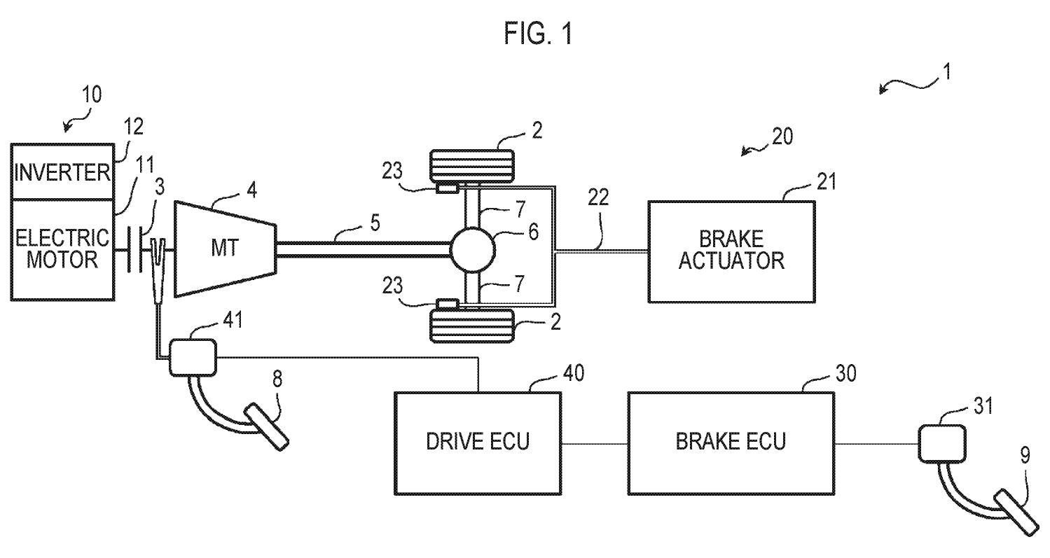

FIG. 1 is a diagram schematically showing a configuration example of an electrified vehicle 1 according to the present embodiment. The electrified vehicle 1 (hereinafter, also simply referred to as a vehicle 1) is a battery electric vehicle (BEV) as an example. The vehicle 1 may be, for example, a hybrid battery electric vehicle (HEV) or a fuel cell battery electric vehicle (FCEV). The vehicle 1 has a drive wheel 2. The drive wheel 2 is, for example, a rear wheel (more specifically, a left and right rear wheel) of the vehicle 1, but may be a front wheel (more specifically, a left and right front wheel) or both a front wheel and a rear wheel.

The vehicle 1 includes an electric motor 11. The electric motor 11 is operated by power supplied from a battery (not shown) to drive the vehicle 1. For example, the electric motor 11 is configured as an electric drive unit 10 together with an inverter 12 for driving the electric motor 11. The inverter 12 is controlled based on a command from a drive ECU 40 to be described later.

The electric motor 11 is coupled to the drive wheel 2 via a clutch 3. More specifically, the electric motor 11 is coupled to a manual transmission (MT) 4 via the clutch 3. The manual transmission 4 is coupled to the drive wheel 2 via, for example, a propeller shaft 5, a differential gear 6, and a drive shaft 7. The clutch 3 is engaged/disengaged by an operation of a clutch pedal 8 by a driver of the vehicle 1.

The vehicle 1 includes a braking device 20. The braking device 20 is configured to apply a regenerative brake torque Trb to the drive wheel 2 by controlling the electric motor 11 and apply a frictional brake torque Tfb to the drive wheel 2 by supplying a brake oil pressure P to a wheel cylinder 23 of the drive wheel 2.

The braking device 20 includes a brake pedal 9, a brake actuator 21, a brake oil pressure pipe 22, and a brake mechanism (only the wheel cylinder 23 is shown). The brake mechanism is disposed in each of wheels of the vehicle 1 including the drive wheel 2. The brake mechanism includes a brake pad and a brake disc as an example, together with the wheel cylinder 23. The brake actuator 21 distributes a brake oil pressure generated by a master cylinder (not shown) according to the pressing of the brake pedal 9 to each wheel cylinder 23 via the brake oil pressure pipe 22. The wheel cylinder 23 operates according to the supplied oil pressure (referred to as a "brake oil pressure P") to press the brake pad against the brake disc, and as a result, the frictional brake torque Tfb is applied to the drive wheel 2 (more specifically, each wheel including the drive wheel 2).

In addition, regarding the application of the regenerative brake torque Trb to the drive wheel 2, the electric motor 11 and the inverter 12 function as a part of the braking device 20. That is, the drive ECU 40 controls the inverter 12 in response to a request from the brake ECU 30, so that the electric motor 11 functions as a generator that generates a negative motor torque Tm that is a source of the regenerative brake torque Trb. A magnitude of the motor torque Tm is controlled by the inverter 12. Power generated by the electric motor 11 is stored in the battery. The regenerative brake torque Trb corresponding to the motor torque Tm is applied to the drive wheel 2.

The vehicle 1 includes the brake ECU 30 and the drive ECU 40 as an example of a "one or more electronic control units (ECUs)" according to the present disclosure. The brake ECU 30 constitutes a brake system of the vehicle 1 together with the braking device 20. The drive ECU 40 constitutes a drive system of the vehicle 1 together with the electric drive unit 10. Each of the brake ECU 30 and the drive ECU 40 may be a combination of a plurality of ECUs.

The brake ECU 30 includes a processor and a storage device. The brake ECU 30 acquires information from various sensors attached to the vehicle 1. The various sensors referred to herein include the brake pedal sensor 31, a wheel speed sensor (not shown), and a front-rear acceleration sensor (not shown), for example. The wheel speed sensor is disposed corresponding to each wheel including the drive wheel 2. The front-rear acceleration sensor detects an acceleration of the vehicle 1 in a front-rear direction. The brake pedal sensor 31 detects an operation state (operation amount or operation force) of the brake pedal 9 by the driver of the vehicle 1. More specifically, the operation amount is a depression amount of the brake pedal 9, and the operation force is a pressing force of the brake pedal 9.

The brake ECU 30 controls the brake actuator 21 based on the information from the various sensors described above, thereby controlling the frictional brake torque Tfb. In addition, the brake ECU 30 can communicate with the drive ECU 40 and outputs a requested regenerative brake torque Trbreq to the drive ECU 40 during regenerative braking, as will be described later. The storage device stores various control programs. The processor reads out the control program from the storage device and executes the control program. As a result, various processes (including a "brake oil pressure increase process" to be described later) related to the control of the vehicle 1 by the brake ECU 30 are realized.

The drive ECU 40 includes a processor and a storage device. The drive ECU 40 acquires information from various sensors attached to the vehicle 1. The various sensors referred to herein include the wheel speed sensor and the front-rear acceleration sensor described above, an accelerator position sensor and a motor rotation angle sensor (resolver) (not shown), and a stroke sensor 41. The accelerator position sensor detects a depression amount of an accelerator pedal (not shown) by the driver of the vehicle 1. The motor rotation angle sensor detects a rotation angle of the electric motor 11. The drive ECU 40 calculates a rotation speed of the electric motor 11 from the detected rotation angle. The stroke sensor 41 detects a depression amount (clutch stroke S) of the clutch pedal 8 by the driver of the vehicle 1.

The drive ECU 40 outputs a requested motor torque Tmreq for controlling the electric motor 11 to the inverter 12 based on the information from the various sensors described above. The storage device stores various control programs. The processor reads out the control program from the storage device and executes the control program. As a result, various processes related to the driving of the vehicle 1 by the drive ECU 40 and a "brake oil pressure increase process" to be described later are realized. In addition, the requested motor torque Tmreq output from the drive ECU 40 to the inverter 12 includes a negative requested motor torque Tmreq calculated according to the requested regenerative brake torque Trbreq from the brake ECU 30 during regenerative braking.

### 2. Regenerative Blended Brake Control

### 2-1. Basic Configuration

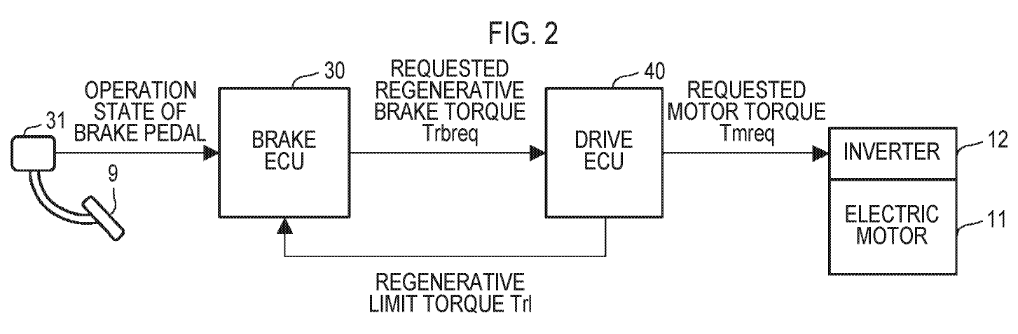

FIG. 2 is a diagram for describing a basic configuration of a regenerative blended brake control.

In a case where the driver presses the brake pedal 9, the brake ECU 30 receives the operation state (operation amount or operation force) of the brake pedal 9 from the brake pedal sensor 31. Then, the brake ECU 30 calculates a requested vehicle brake torque Tbreq based on the received operation state. The requested vehicle brake torque Tbreq is a requested value of a braking torque Tb of an entirety of the vehicle 1.

On the other hand, the drive ECU 40 calculates a "regenerative limit torque Trl" and transmits the calculated regenerative limit torque Trl to the brake ECU 30 (see FIG. 2). More specifically, the drive ECU 40 calculates the regenerative limit torque Trl based on, for example, the rotation speed of the electric motor 11 and a state of charge (SOC) of the battery. The calculation and transmission of the regenerative limit torque Trl are executed, for example, during braking of the vehicle 1 in a case where the brake pedal 9 is depressed by the driver through the brake pedal sensor 31.

The brake ECU 30 distributes the calculated requested vehicle brake torque Tbreq to the requested regenerative brake torque Trbreq and a requested frictional brake torque Tfbreq. In this case, the brake ECU 30 distributes the requested vehicle brake torque Tbreq to the requested regenerative brake torque Trbreq with the regenerative limit torque Trl received from the drive ECU 40 as an upper limit. That is, the brake ECU 30 calculates the requested regenerative brake torque Trbreq within a range that does not exceed the regenerative limit torque Trl. Then, the brake ECU 30 distributes the remainder obtained by subtracting the requested regenerative brake torque Trbreq from the requested vehicle brake torque Tbreq to the requested frictional brake torque Tfbreq.

More specifically, in a case where the requested vehicle brake torque Tbreq is higher than the regenerative limit torque Trl, the brake ECU 30 calculates the requested regenerative brake torque Trbreq equal to the regenerative limit torque Trl. On the other hand, in a case where the requested vehicle brake torque Tbreq is equal to or lower than the regenerative limit torque Trl, the brake ECU 30 calculates the requested regenerative brake torque Trbreq equal to the requested vehicle brake torque Tbreq. That is, the entire requested vehicle brake torque Tbreq is distributed to the requested regenerative brake torque Trbreq. Therefore, in a case where the requested vehicle brake torque Tbreq is equal to or lower than the regenerative limit torque Trl, the requested vehicle brake torque Tbreq is not distributed to the requested frictional brake torque Tfbreq. That is, the requested frictional brake torque Tfbreq is zero.

The brake ECU 30 transmits the calculated requested regenerative brake torque Trbreq to the drive ECU 40 (see FIG. 2). In addition, the brake ECU 30 controls the brake actuator 21 such that the calculated requested frictional brake torque Tfbreq is generated.

The drive ECU 40 calculates the requested motor torque Tmreq from the requested regenerative brake torque Trbreq received from the brake ECU 30. More specifically, the drive ECU 40 calculates the requested motor torque Tmreq in consideration of a constraint on the drive system (for example, a gear ratio between the electric motor 11 and the drive wheel 2 and a transmission efficiency K of the clutch 3). Then, the drive ECU 40 transmits the calculated requested motor torque Tmreq to the inverter 12 (see FIG. 2). As a result, the electric motor 11 is controlled by the inverter 12 to generate the requested motor torque Tmreq corresponding to the requested regenerative brake torque Trbreq.

### 2-2. Brake Oil Pressure Increase Process Based on Clutch Stroke

The electrified vehicle 1 is an electrified vehicle including an electric motor coupled to a drive wheel via a clutch. In such an electrified vehicle, in a case where a regenerative brake torque does not act on the drive wheel as a clutch pedal is depressed during execution of regenerative braking, the driver is required to press the brake pedal.

Therefore, in the present embodiment, in a case where the clutch pedal 8 is depressed during execution of the regenerative braking in which the regenerative brake torque Trb is applied to the drive wheel 2 (for example, see FIG. 2), the "one or more ECUs" of the vehicle 1 execute the following "brake oil pressure increase process". According to the brake oil pressure increase process, the braking device 20 is controlled such that the brake oil pressure P corresponding to the clutch stroke S detected by the stroke sensor 41 is added to the wheel cylinder 23 of the drive wheel 2.

The addition of the brake oil pressure P by the brake oil pressure increase process is executed, for example, such that the frictional brake torque Tfb is increased in a situation in which the frictional brake torque Tfb is applied to the drive wheel 2 together with the regenerative brake torque Trb. Alternatively, the addition of the brake oil pressure P is executed such that the frictional brake torque Tfb is applied in a situation in which only the regenerative brake torque Trb is applied to the drive wheel 2.

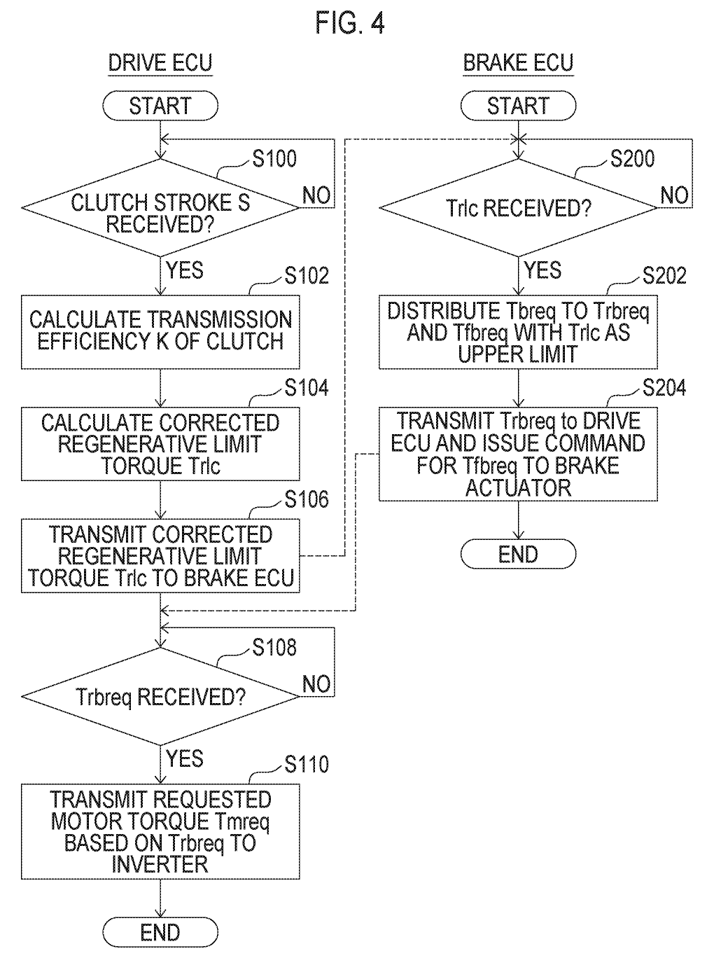

More specifically, for example, the control may be performed like a process of a flowchart shown in FIG. 4 to be described later. That is, the brake oil pressure P added by the brake oil pressure increase process in a case where the clutch stroke S is large may be controlled to be larger than that in a case where the clutch stroke S is small.

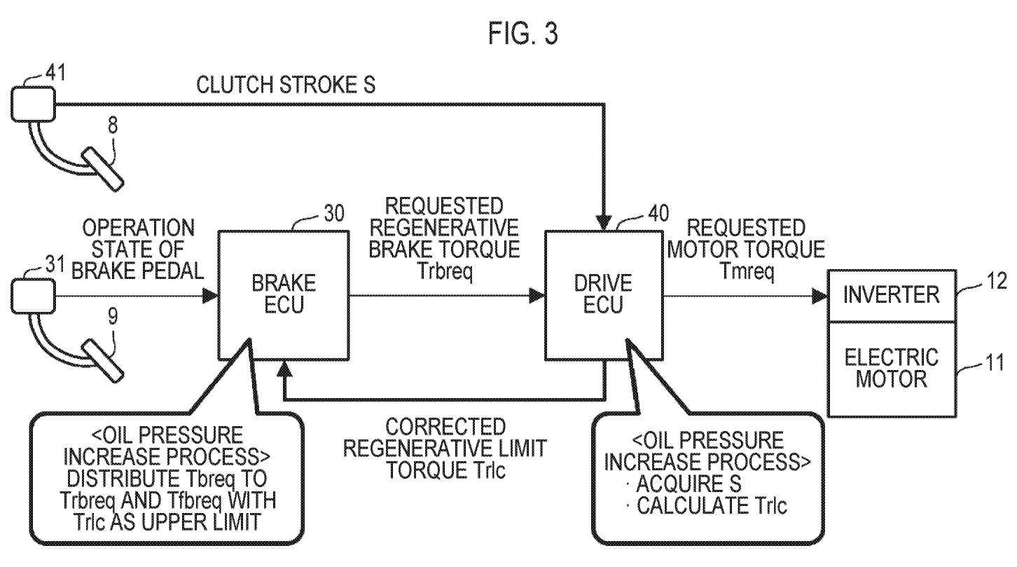

FIG. 3 is a diagram for describing an outline of a brake oil pressure increase process according to the present embodiment. Here, a difference from the basic configuration of the regenerative blended brake control shown in FIG. 2 will be described. In the present embodiment, the brake oil pressure increase process is executed by cooperation between the brake ECU 30 and the drive ECU 40 corresponding to the "one or more ECUs" described above as an example.

First, a brake oil pressure increase process executed on a side of the drive ECU 40 will be described. As shown in FIG. 3, in a case where the clutch pedal 8 is depressed by the driver during execution of regenerative braking, the drive ECU 40 receives (acquires) a clutch stroke S from the stroke sensor 41. Then, the drive ECU 40 corrects the regenerative limit torque Trl according to the received clutch stroke S. In other words, the drive ECU 40 calculates a corrected regenerative limit torque Trlc according to the clutch stroke S (see S104 to be described later for details). The drive ECU 40 transmits the calculated corrected regenerative limit torque Trlc to the brake ECU 30.

Next, a brake oil pressure increase process executed on a side of the brake ECU 30 will be described. As shown in FIG. 3, the brake ECU 30 distributes the requested vehicle brake torque Tbreq to the requested regenerative brake torque Trbreq and the requested frictional brake torque Tfbreq with the corrected regenerative limit torque Trlc received from the drive ECU 40 as an upper limit.

FIG. 4 is a flowchart showing details of a brake oil pressure increase process according to the present embodiment. The process of the flowchart is started, for example, in a case where the pressing of the brake pedal 9 by the driver is detected. The process of the present flowchart may be repeatedly executed during braking of the vehicle 1 at a predetermined control cycle.

In S100, the drive ECU 40 determines whether the clutch stroke S in a case where the clutch pedal 8 is depressed is received from the stroke sensor 41. As a result, in a case where the clutch stroke S is received (S100; Yes), the process proceeds to S102.

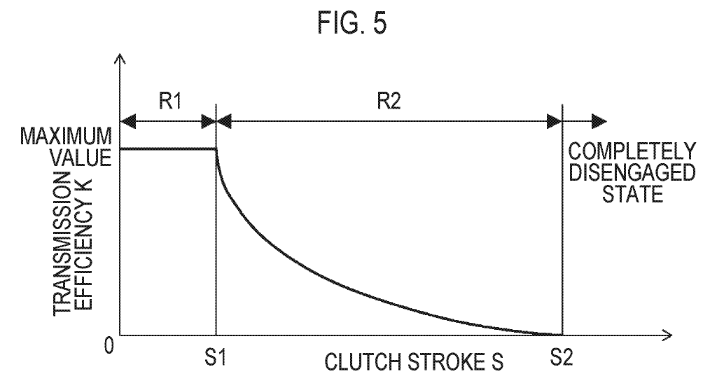

In S102, the drive ECU 40 calculates the transmission efficiency K of the clutch 3 corresponding to the received clutch stroke S. FIG. 5 is a graph showing a relationship between the clutch stroke S and the transmission efficiency K. The storage device of the drive ECU 40 stores relationship information (for example, a map or a relational expression) indicating a relationship between the clutch stroke S and the transmission efficiency K as shown in FIG. 5. The clutch stroke S takes a value of zero in a case where the clutch pedal 8 is not depressed, and increases as the depression amount increases. The transmission efficiency K basically decreases as the clutch stroke S increases. More specifically, in the example shown in FIG. 5, the transmission efficiency K takes a maximum value in a range R1 of the clutch stroke S from zero to S1. Then, in a range R2 from S1 to S2 (> S1), the transmission efficiency K decreases from the maximum value to zero. S2 corresponds to a minimum value of the clutch stroke S at which the clutch 3 is in a completely disengaged state. The drive ECU 40 calculates (acquires) the transmission efficiency K corresponding to the clutch stroke S received in S100 from the relationship information described above. In the range R2 (see FIG. 5), the transmission efficiency K is calculated to decrease as the clutch stroke S increases. Thereafter, the process proceeds to S104.

In S104, the drive ECU 40 calculates the corrected regenerative limit torque Trlc by multiplying the transmission efficiency K calculated in S102 by the regenerative limit torque Trl (base value). As already described, the regenerative limit torque Trl (base value) can be calculated based on, for example, the rotation speed of the electric motor 11 and the remaining charge of the battery. According to the corrected regenerative limit torque Trlc, in the range R2 (see FIG. 5), the regenerative limit torque Trl is corrected to decrease as the clutch stroke S increases. As described above, according to the process of S104, the corrected regenerative limit torque Trlc in consideration of the transmission efficiency K of the clutch 3 is calculated.

In S106 following S104, the drive ECU 40 transmits the calculated corrected regenerative limit torque Trlc to the brake ECU 30.

In S200, the brake ECU 30 determines whether the corrected regenerative limit torque Trlc is received from the drive ECU 40. As a result, in a case where the corrected regenerative limit torque Trlc is received (S200; Yes), the process proceeds to S202.

In S202, the brake ECU 30 calculates the requested vehicle brake torque Tbreq based on the operation state of the brake pedal sensor 31. Then, the brake ECU 30 distributes the requested vehicle brake torque Tbreq to the requested regenerative brake torque Trbreq and the requested frictional brake torque Tfbreq while using the received corrected regenerative limit torque Trlc as an upper limit. The distribution of the torque is performed by a method described in Section 2-1 above.

As a result, in the range R2 (see FIG. 5), the requested regenerative brake torque Trbreq is distributed to have the same tendency as the corrected regenerative limit torque Trlc. That is, the requested regenerative brake torque Trbreq is distributed to be lower as the clutch stroke S is larger. The supplementary description will be described below. A case where the requested vehicle brake torque Tbreq is higher than the regenerative limit torque Trl (base value) will be described. In this case, in a case where the corrected regenerative limit torque Trlc is calculated to be lower as the clutch stroke S is larger, the requested regenerative brake torque Trbreq is also distributed to be lower as the clutch stroke S is larger. In addition, a case where the requested vehicle brake torque Tbreq is equal to or lower than the regenerative limit torque Trl (base value) will be described. In this case, in a case where the corrected regenerative limit torque Trlc is calculated to be lower as the clutch stroke S is larger, the corrected regenerative limit torque Trlc is likely to be lower than the requested vehicle brake torque Tbreq. Then, in a case where the corrected regenerative limit torque Trlc is lower than the requested vehicle brake torque Tbreq, the requested regenerative brake torque Trbreq distributed from the requested vehicle brake torque Tbreq is limited by the corrected regenerative limit torque Trlc. That is, the requested regenerative brake torque Trbreq is lowered.

On the other hand, the requested frictional brake torque Tfbreq is distributed to have a tendency to increase as the clutch stroke S increases, contrary to the requested regenerative brake torque Trbreq. In addition, in a case where the clutch stroke S is equal to or larger than S2 (see FIG. 5), the corrected regenerative limit torque Trlc is zero, so that the requested regenerative brake torque Trbreq takes a value of zero. Then, the requested frictional brake torque Tfbreq is equal to the requested vehicle brake torque Tbreq. Thereafter, the process proceeds to S204.

In S204, the brake ECU 30 transmits the requested regenerative brake torque Trbreq to the drive ECU 40. In addition, the brake ECU 30 issues a command for the calculated requested frictional brake torque Tfbreq to the brake actuator 21. As described above, in the range R2 (see FIG. 5), the requested frictional brake torque Tfbreq is distributed to have a tendency to increase as the clutch stroke S increases. The brake oil pressure P is controlled based on the requested frictional brake torque Tfbreq distributed in this manner. That is, the brake actuator 21 (braking device 20) is controlled such that the brake oil pressure P is larger in a case where the clutch stroke S is larger than in a case where the clutch stroke S is smaller.

In addition, in S108 following S106, the drive ECU 40 determines whether the requested regenerative brake torque Trbreq is received from the brake ECU 30. As a result, in a case where the requested regenerative brake torque Trbreq is received (S108; Yes), the process proceeds to S110.

In S110, as described above, the drive ECU 40 calculates the requested motor torque Tmreq from the requested regenerative brake torque Trbreq received from the brake ECU 30. Then, the drive ECU 40 transmits the calculated requested motor torque Tmreq to the inverter 12. As a result, the electric motor 11 is controlled by the inverter 12 to generate a negative requested motor torque Tmreq corresponding to the requested regenerative brake torque Trbreq.

As described above, according to the brake oil pressure increase process according to the present embodiment, it is possible to add the brake oil pressure P having an appropriate magnitude in a case where the clutch pedal 8 is depressed during the execution of the regenerative braking. More specifically, according to the brake oil pressure increase process according to the present embodiment, it is possible to add the brake oil pressure P corresponding to a decrease in the regenerative brake torque Trb corresponding to the clutch stroke S. Accordingly, it is possible to suppress a change in a vehicle braking force (vehicle braking torque Tb) while avoiding or suppressing the driver from pressing the brake pedal 9.

More specifically, a transmitted torque of the clutch 3 in a case where the clutch pedal 8 is depressed is proportional to the transmission efficiency K, and the transmission efficiency K is changed according to the clutch stroke S (see FIG. 5). Therefore, a decrease amount of the regenerative brake torque Trb with the pressing of the clutch pedal 8 varies depending on the clutch stroke S. Therefore, in a case where a method (comparative example) that does not take into account the magnitude of the clutch stroke S is used, it may be difficult to appropriately suppress a change in the vehicle braking force without depending on the clutch stroke S. Specifically, the comparative example is a method of uniformly increasing the brake oil pressure P by a predetermined fixed value in response to the pressing of the clutch pedal 8. For example, in a case where the clutch stroke S is short (for example, a value close to S1 in FIG. 5), the brake oil pressure P may be excessive depending on the magnitude of the fixed value. As a result, the driver may be requested to further operate the brake pedal 9. On the other hand, according to the brake oil pressure increase process according to the present embodiment, the brake oil pressure P corresponding to the clutch stroke S is added, so that it is possible to appropriately suppress a change in the vehicle braking force as compared with the comparative example.

What is claimed is:

1. An electrified vehicle comprising:
an electric motor connected to a drive wheel via a clutch;
a stroke sensor configured to measure a clutch stroke that is a depression amount of a clutch pedal for operating the clutch;
a braking device configured to apply regenerative brake torque to the drive wheel by controlling the electric motor, and apply frictional brake torque to the drive wheel by supplying a brake oil pressure to a wheel cylinder of the drive wheel; and
one or more electronic control units,
wherein the one or more electronic control units are configured to execute, when the clutch pedal is depressed during execution of regenerative braking in which the regenerative brake torque is applied to the drive wheel, an oil pressure increase process of controlling the braking device such that the brake oil pressure corresponding to the clutch stroke measured by the stroke sensor is applied to the wheel cylinder.

2. The electrified vehicle according to claim 1, wherein the one or more electronic control units are configured to control the braking device such that the brake oil pressure that is applied via the oil pressure increase process is larger in a case where the clutch stroke is large than in a case where the clutch stroke is small.

3. The electrified vehicle according to claim 2, wherein:
the one or more electronic control units are configured to
calculate requested vehicle brake torque based on an operation state of a brake pedal, and
distribute the requested vehicle brake torque to requested regenerative brake torque with regenerative limit torque as an upper limit, and distribute remainder to requested frictional brake torque, the remainder being obtained by subtracting the requested regenerative brake torque from the requested vehicle brake torque; and
the oil pressure increase process includes correcting the regenerative limit torque such that the regenerative limit torque is lower as the clutch stroke measured by the stroke sensor during the execution of the regenerative braking is larger.

4. The electrified vehicle according to claim 3, wherein the oil pressure increase process includes correcting, by calculating transmission efficiency of the clutch based on a relationship between the clutch stroke and the transmission efficiency such that the transmission efficiency is lower as the clutch stroke is larger and by multiplying a base value of the regenerative limit torque by the transmission efficiency that is calculated, the regenerative limit torque such that the regenerative limit torque is lower as the clutch stroke is larger.
